(19) United States
(12) Patent Application Publication
(10) Pub. No.: US 2015/0109664 A1
(43) Pub. Date: Apr. 23, 2015

(54) CORNER REFLECTOR

(71) Applicant: GUS PRAEZISION IN KUNSTSTOFF, GLAS UND OPTIK GMBH & CO. KG, LUEBBECKE (DE)

(72) Inventor: DIETER KUHNKE, LUEBBECKE (DE)

(21) Appl. No.: 14/517,039

(22) Filed: Oct. 17, 2014

(30) Foreign Application Priority Data
Oct. 18, 2013 (DE) 10 2013 111 541.1
Nov. 26, 2013 (DE) 102013113024.0

(51) Int. Cl. G02B 23/08; G02B 23/16; G02B 1/11; B60R 1/10; G02B 27/00

(52) U.S. Cl. CPC G02B 23/08; B60R 1/10; G02B 27/0006; G02B 1/11; G02B 23/16
USPC 359/402

(57) ABSTRACT

A periscope includes a prism block with upper and lower deflection mirrors, in a housing with a vision unit and a reflector unit. A display unit is disposed opposite the vision unit, above the lower deflection mirror on a section of the rear side that is parallel to the front side. A reflector unit image can be seen exclusively on a lower region and a display image can be seen exclusively on an upper region of the vision unit. The upper region corresponds to at least half the height of the vision unit. An air gap is present between the display unit and the prism block, and a heating film or an ITO coating (indium-tin oxide) for heating the optical surface and/or an anti-frosting nano coating is applied to the surface of the prism block opposite the display unit and/or to the display unit.

The invention relates to a periscope for armored vehicles according to the preamble of the independent claim.

A periscope arrangement consisting of a prism block in a housing with a vision unit and a reflector unit and with a display unit disposed opposite the vision unit side for displaying information in the vision unit without a deflection mirror is known, see DE 36 27 716 A 1, which comprises a very narrow single-sided or two-sided display field, with which only a small amount of information can be merged into the vision unit of a periscope.

Disadvantages with said previously known periscope arrangement are for one thing the only very limited information content of the small display field and for another thing the nature of the arrangement on the housing across an air gap to the prism block, so that enclosed moist air can cause moisture mist and condensation on the prism block or the display unit, which adversely affects the functional reliability of the periscope.

The object of the invention is to provide a periscope for armored vehicles that significantly improves the display capability in a reliable embodiment.

The solution of said object arises in conjunction with the features of the preamble according to the invention from the technical features of the characterizing part of the first claim, especially in that a reflector unit image can be seen on a lower region and a display image of the display unit can be seen on an upper region of the vision unit and that the upper region corresponds to at least half of the height of the vision unit.

Said inventive novelty enables binocular information merging of information of all types by means of an electronic display, even roadway information or night vision inserts, which are also possible in a binocular manner. Furthermore, with full display function the full field of view of the periscope can be used simultaneously without changes of the viewing position of the observer being necessary, so that simultaneous monitoring capabilities are provided at the same time.

Another advantage of the periscope according to the invention is that the full function in relation to normal use of the field of view is retained even in the event of a power failure.

Further advantageous embodiments of the object of the invention will become apparent in the dependent claims below and in combinations thereof.

According to a particularly preferred embodiment of the invention, the periscope is fitted with a heating means between the display unit and the prism block to prevent moisture misting and condensation in the air gap, so that the function of the display unit is always guaranteed even in adverse environmental conditions.

Accordingly, in a preferred embodiment of the invention the heating means consists of a heating film or an ITO coating (indium tin oxide) on the area of the prism block opposite the display unit for heating the optical surfaces, wherein said heating means operate as electrical resistance heating means.

In the case of a different or even additional embodiment of the invention, the display unit and/or the surface of the prism block opposing it is provided with a nano coating to protect against frosting, so that even without a heating means or if the heating means are not operating, the display image of the display unit remains clearly visible in the vision unit.

In order to improve the transparency and the brilliance of the display image, anti-reflective glass is disposed in front of the vision unit in a further improved embodiment.

In order to ensure the full functionality of the display unit, the prism block is made of glass or PMMA.

Moreover, the periscope according to the invention is provided with the kinds of external dimensions that coincide with commercial periscopes, so that the periscope according to the invention can be exchanged for a known periscope without structural changes.

Furthermore, it is advantageous that the display unit is disposed on the housing of the periscope so as to be replaceable in the case of a defect, so that replacement can be carried out rapidly and simply.

An exemplary embodiment of the invention is described in detail below using figures. In the figures:

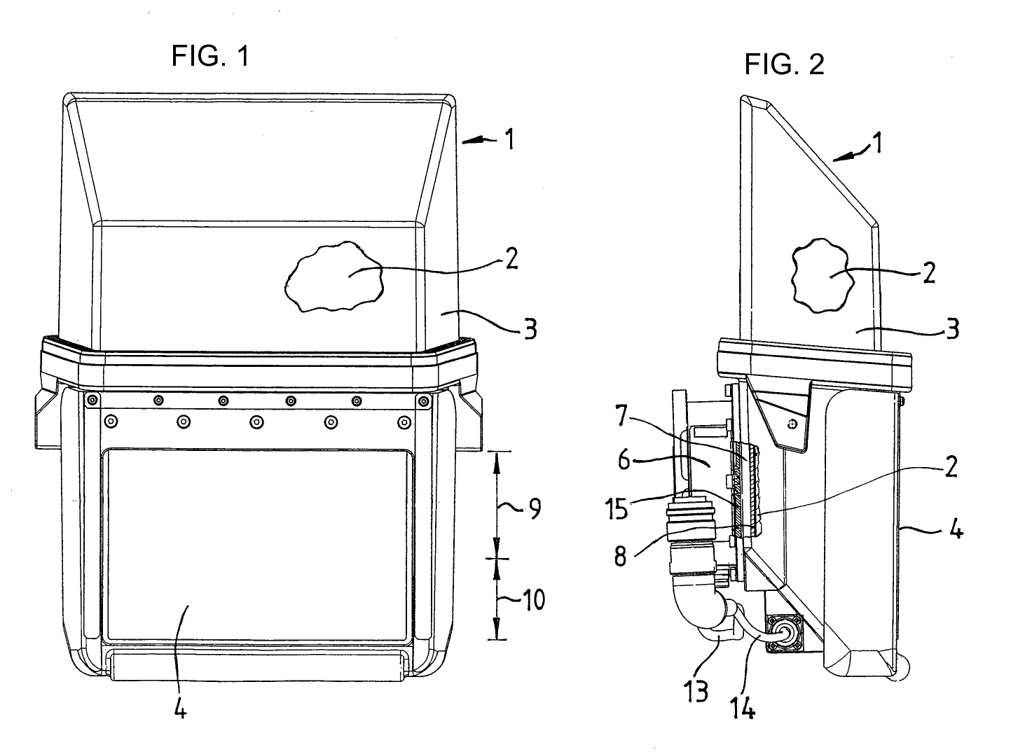

FIG. 1 shows a periscope from behind with a view of the vision unit side,

FIG. 2 shows the periscope according to FIG. 1 in a side view from the left,

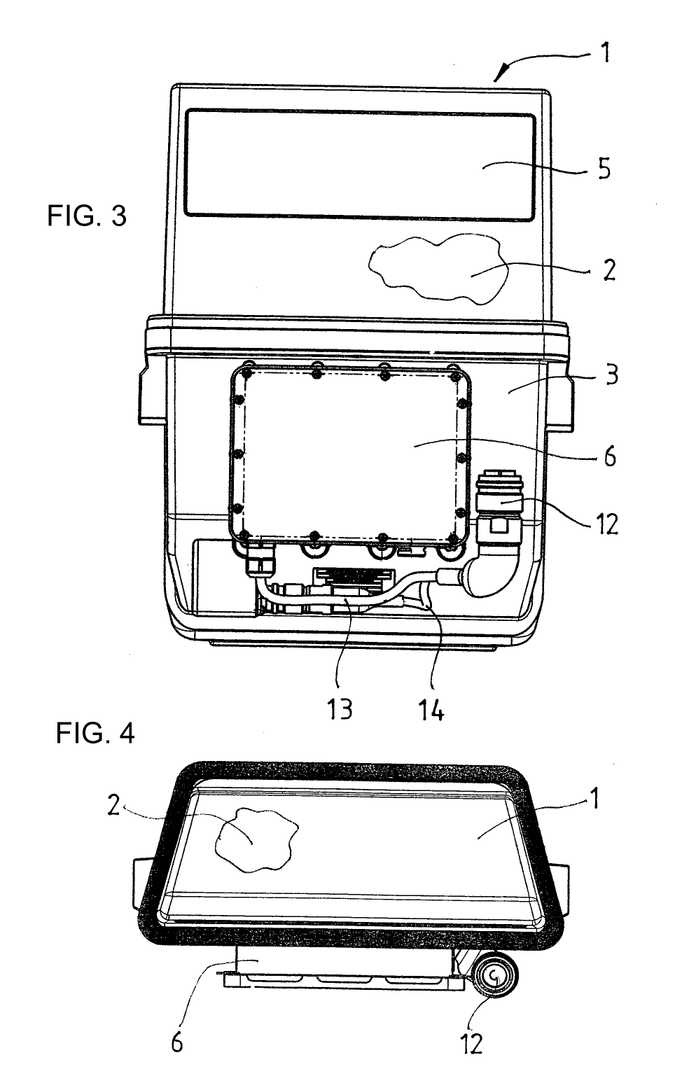

FIG. 3 shows the periscope according to FIGS. 1 and 2 in a view from the front of the reflector unit side, and

FIG. 4 shows a top view of a periscope according to FIGS. 1 to 3

The periscope 1 for armored vehicles consists of a prism block 2 in a housing 3 with a vision unit 4 and a reflector unit 5, as well as of a display unit 6 disposed opposite the vision unit side for the display of information in the vision unit 4 without a deflection mirror, wherein a reflector unit image can be seen on a lower region 10 and a display image of the display unit 6 on an upper region 9 of the viewing unit 4 simultaneously and the upper region 9 corresponds to at least half the height of the vision unit 4. In this case the display 15 of the display unit can e.g. have a display size of 180×80 mm as a display area.

There is an air gap 7 between the display unit 6 and the prism block 2 and the periscope 1 is provided with a heating means to prevent moisture mist and condensation there, wherein said heating means can be fitted as a heating film 8 applied to the surface of the prism block 2 opposite the display unit 6 or as an ITO coating of indium tin oxide for heating the optical surface, just as the display 15 of the display unit 6 can be provided with such a heating film 8 or an ITO coating.

Alternatively or additionally, the display unit 6 and/or the opposing surface of the prism block 2 or the heating films 8 or ITO coatings disposed thereon can be provided with an additional anti-frosting nano coating.

In order to improve the transparency and the brilliance of the display image, anti-reflective glass, which is not shown in the drawing, can be disposed in front of the vision unit 4.

The prism block 2 consists of glass or PMMA in order to ensure the full functionality of the display unit 6. In this case the housing 2 of the periscope 1 has external dimensions that coincide with those of commercial periscopes, so that it can be exchanged with a commercial periscope without structural changes.

The display unit 6 can also be disposed on the housing 2 of the periscope 1 to as to be exchangeable in order to be able to be replaced quickly following a defect.

The periscope 1 is supplied with power by means of a connector plug 12 and a power supply 13 for the display unit 6 and a power supply 14 for the heating means.

1-6. (canceled)

7. A periscope for armored vehicles, comprising:
a housing formed with a vision unit and a reflector unit;
a prism block disposed in said housing;
a display unit disposed opposite said vision unit and configured for displaying information in said vision unit without a deflection mirror in between;
said vision unit having a given height and having a lower region and an upper region;
wherein a reflector unit image is visible in said lower region and a display image of said display unit is visible in said upper region of said vision unit; and
wherein said upper region of said vision unit encompasses at least one half of the given height of said vision unit.

8. The periscope according to claim 7, wherein said display unit and said prism block are disposed to form an air gap therebetween, and further comprising a heating means for preventing moisture mist or condensation.

9. The periscope according to claim 8, which comprises a heating film or an indium-tin oxide coating for heating an optical surface disposed on a surface of said prism block opposite said display unit.

10. The periscope according to claim 8, which comprises a heating film or an indium-tin oxide coating disposed on said display unit.

11. The periscope according to claim 8, wherein one or both of said display unit and/or a surface of said prism block opposite said display unit is provided with an anti-frosting nano-coating.

12. The periscope according to claim 7, which comprises antireflective glass disposed in front of said vision unit for improving a transparency and a brilliance of the display image.

13. The periscope according to claim 7, wherein said prism block consists of a material selected from the group consisting of glass and PMMA for ensuring a full functionality of the display.

14. The periscope according to claim 7, configured with exterior dimensions corresponding to exterior dimensions of commercial periscopes, enabling the periscope to be exchanged with commercial periscopes without structural changes.

15. The periscope according to claim 7, wherein said display unit is replaceably mounted in said housing of the periscope.
